(19) United States
(12) Patent Application Publication
(10) Pub. No.: US 2023/0079663 A1
(43) Pub. Date: Mar. 16, 2023

(54) OPTIMIZED DISTRIBUTED PRIVATE MATRIX MULTIPLICATION

(71) Applicant: Apple Inc., Cupertino, CA (US)

(72) Inventors: Bernhard Raaf, Munich (DE); Sabine Roessel, Munich (DE)

(21) Appl. No.: 17/942,087

(22) Filed: Sep. 9, 2022

Related U.S. Application Data
(60) Provisional application No. 63/243,726, filed on Sep. 13, 2021.

(51) Int. Cl. G06F 17/16; G06F 16/22; G06F 21/62

(52) U.S. Cl. CPC G06F 17/16; G06F 16/2237; G06F 21/62

(57) ABSTRACT

Methods, systems, and computer programs for distributed processing of a matrix data structure is disclosed. In one aspect, the method can include obtaining a first matrix data structure (DS), segmenting the obtained matrix DS into a set of M different matrix DS portions, segmenting each of the different M matrix DS portions into respective sets of K matrix DS sub-portions, for each of the respective sets of K matrix DS sub-portions: generating an obfuscation matrix having the same dimensions as each of the K matrix DS sub-portions, and generating, by one or more computers, an obfuscated representation of each respective set of K matrix DS sub-portions that includes (i) the K matrix DS sub-portions and (ii) the obfuscation matrix, and transmitting data representing each (of the N) obfuscated representation of the (K) matrix DS sub-portions of the respective sets of M matrix DS portions to a different computer for processing.

### CROSS-REFERENCE TO RELATED APPLICATIONS

This application claims the benefit of U.S. Provisional Patent Application No. 63/243,726, filed Sep. 13, 2021, which is herein incorporated by reference in its entirety.

### BACKGROUND

Conventional system exist for obtaining a matrix (A) and performing single split of the obtained matrix (A) into K stripes Aᵢ that are to be obfuscated and then distributed amongst different worker computers for processing. The goal with splitting the matrix (A) into K stripes Aᵢ is to achieve overall speed increases by using a plurality of worker computers to process the K stripes in parallel.

### SUMMARY

Though conventional systems for distributed processing of K stripes of a matrix A exists, such systems have drawbacks. For example, such systems are often unable to harness maximum benefit from the increase in parallelization when K grows too large, as the system design changes necessary accommodate encoding processes for such large numbers of K often offsets the benefits that can be achieved via the increased parallelization.

The present disclosure addresses such deficiencies in conventional systems by enabling further partitioning of matrix data structure portions into matrix data structure sub-portions without the increases processing load that results in conventional systems. This solution is achieved by the present disclosure by using an obfuscation process that obfuscates sets of matrix data structure sub-portions as opposed to an obfuscation of each sub-portion, as would occur with conventional systems. The present disclosure can thus increase parallelization and throughput without exponentially or at least polynomial increasing computational resource expenditure by distributor computers.

The present disclosure generally relates to a system and method for optimized distributed private matrix multiplication that improves the performance of a system performing matrix multiplication. The system achieves these improvements in performance relative to conventional systems by providing an optimized system that can create additional stripes (e.g., sub-stripes) without increasing the overall number of obfuscated matrix data structures which would be obfuscated and decoded under conventional methods. Accordingly, the present disclosure, can facilitate greater segmentation of a matrix to enable greater parallelization without increasing computational costs on the matrix distribution side the network during matrix data structure generation and obfuscation.

According to one innovative aspect of the present disclosure, a method for distributed processing of a matrix data structure is disclosed. In one aspect, the method can include actions of obtaining, by one or more computers, a first matrix data structure, segmenting, by one or more computers, the obtained matrix data structure into a set of M different matrix data structure portions, wherein M is an integer number greater than 1, segmenting, by one or more computers, each of the different M matrix data structure portions into respective sets of K matrix data structure sub-portions, where K is an integer number greater than 1, for each of the respective sets of K matrix data structure sub-portions: generating, by one or more computers, an obfuscation matrix having the same dimensions as each of the K matrix data structure sub-portions, generating, by one or more computers, an obfuscated representation of each respective set of K matrix data structure sub-portions that includes (i) the K matrix data structure sub-portions and (ii) the obfuscation matrix, and transmitting, by one or more computers, data representing each (of the N) obfuscated representation of the (K) matrix data structure sub-portions of the respective sets of M matrix data structure portions to a different computer for processing.

Other aspects includes systems, apparatus, and computer programs for performing the actions of the aforementioned methods.

The innovative method can include other optional features. For example, in some implementations, the method can further include receiving, by one or more computers, result data that includes a resultant matrix from each of the different computers, wherein each resultant matrix of the resultant matrices is a product of (a) a different matrix and (b) an obfuscated representation of one of the M matrix data structure sub-portions, and decoding, by one or more computers, the result data. In such implementations, decoding the result data can include identifying, by one or more computers and for each resultant matrix, a particular resultant matrix that is a product of the different matrix and one of the K matrix data structures.

In some implementations, generating, by one or more computers, an obfuscated representation of each respective set of K matrix data structure sub-portions that includes (i) the K matrix data structure portions and (ii) the obfuscation matrix can include generating, by one or more computers, an expression that corresponds to a polynomial having at least one of the K matrix data structure sub-portions as a coefficient and an obfuscation matrix as coefficients.

In some implementations, method can further include receiving, by one or more computers, a set of result data from each of the different computers, wherein each set of result data includes data representing an expression that corresponds to a product of (a) a different matrix and (b) the generated expression, and decoding, by one or more computers, the result data. In such implementations, decoding the result data comprises can include determining, by one or more computers, that the generated expression in each set of result data has unknown parameters, and identifying, by one or more computers and based on the generated expressions the relevant unknown parameters for each expression, a particular resultant matrix that is a product of the different matrix and one of the K matrix data structures.

In some implementations, transmitting, by one or more computers, data representing each (of the N) obfuscated representation of the (K) matrix data structure sub-portions of the respective sets of M matrix data structure portions to a different computer for processing can include for each particular obfuscated representation of the N obfuscated representations: transmitting the particular obfuscated representation to a different remote computer that is remote from the one or more computers using one or more networks.

In some implementations, transmitting, by one or more computers, data representing each (of the N) obfuscated representation of the (K) matrix data structure sub-portions of the respective sets of M matrix data structure portions to a different computer for processing can include for each particular obfuscated representation of the N obfuscated representations: transmitting the particular obfuscated representation to a different processing core of one the one or more computers.

According to another innovative aspect of the present disclosure, another method for distributed processing of a matrix data structure is disclosed. In one aspect, the method can include actions of obtaining, by one or more computers, a first matrix data structure, segmenting, by one or more computers, the obtained matrix data structure into a set of K different matrix data structure portions, wherein K is an integer number greater than 1, generating, by one or more computers, an obfuscated representation of the K different matrix data structure portions that includes (i) the K matrix data structure portions and (ii) the obfuscation matrix, generating a set of N obfuscated representations of the K matrix data structure portions, segmenting, by one or more computers, each of the N obfuscated representations of each of the K different matrix data structure portions into respective sets of M obfuscated sub-representations of the K matrix data structure portions, where M is an integer number greater than 1, and transmitting, by one or more computers, data representing each respective set of the N*M obfuscated sub-representations (of the K matrix data structure portion) to a different computer for processing.

Other aspects includes systems, apparatus, and computer programs for performing the actions of the aforementioned methods.

According to another innovative aspect of the present disclosure, a method for distributed processing of a matrix data structure is disclosed. In one aspect the method can include actions of obtaining, by one or more computers, a first matrix data structure, obtaining, by one or more computers, a second matrix data structure, segmenting, by one or more computers, the obtained first matrix data structure into a set of K different first matrix data structure portions, wherein K is an integer number greater than 1, generating, by one or more computers, a first obfuscation matrix having the same dimensions as each of the K matrix data structure portions of the first matrix data structure, generating, by one or more computers, a first set of N obfuscated representation of the set of K matrix data structure portions that includes (i) the K matrix data structure portions and (ii) the first obfuscation matrix, segmenting, by one or more computers, each of the different N obfuscated representation of the set of K matrix data structure portions of the first matrix data structure into respective sets of M first matrix data structure sub-portions, where Mis an integer number greater than 1, segmenting, by one or more computers, the obtained second matrix data structure into a set of L different second matrix data structure portions, wherein L is an integer number greater than 1, generating, by one or more computers, a second obfuscation matrix having the same dimensions as each of the L matrix data structure portions of the second matrix data structure, generating, by one or more computers, a second set of N obfuscated representations of the set of L matrix data structure portions that includes (i) the L matrix data structure portions and (ii) the second obfuscation matrix, segmenting, by one or more computers, each of the different N obfuscated representations of the set of L matrix data structure portions of the second matrix data structures into respective sets of [symbol] second matrix data structure sub-portions, where [symbol] is an integer number greater than 1 and, and transmitting, by one or more computers, data representing obfuscated representation pairs to different computers for processing, wherein each obfuscated representation pair includes (i) an obfuscated representation of a first matrix data structure sub-portion and a corresponding second matrix data structure sub-portion.

Other aspects includes systems, apparatus, and computer programs for performing the actions of the aforementioned methods.

The innovative method can include other optional features. For example, in some implementations, the first matrix data structure corresponds to input data, and the second matrix data structure corresponds to a trained feature set of a machine learning model.

These and other features are apparent from the description, drawings, and claims of the present disclosure.

### BRIEF DESCRIPTION OF THE DRAWINGS

FIG. 1 is an example of block diagram of an example of a system for optimized distributed private matrix multiplication.

FIG. 1A an example of a process flow for distributed processing of a matrix data structure using post-partitioning obfuscation that is one-sided obfuscation.

FIG. 2 is a flowchart of an example of a method for distributed processing of a matrix data structure using post-partitioning obfuscation that is one-sided obfuscation.

FIG. 3 is a flowchart of an example of a method for distributed processing of a matrix data structure using pre-segmentation obfuscation that is one-sided obfuscation.

FIG. 3A is an example of a process flow for distributed processing of a matrix data structure using pre-segmentation obfuscation that is one-sided obfuscation.

FIGS. 4-4A is a flowchart of an example of a method for optimized distributed private matrix multiplication using pre-segmentation obfuscation that is two-sided obfuscation.

FIG. 4B is an example of a process flow for a process for distributed processing of a matrix data structure using pre-segmentation obfuscation that is two-sided obfuscation.

FIG. 5 is a block diagram of system components that can be used to implement a system for optimized private matrix multiplication.

### DETAILED DESCRIPTION

The present disclosure is directed to a system and method for optimized distributed private matrix multiplication. Conventional systems have one or more distribution computers that are configured to split an obtained matrix data structure into a plurality of matrix data structure portions, which can then be obfuscated and distributed, by the distribution computer, across multiple different distributed worker computers for parallel processing. However, such conventional systems become less efficient as the number of matrix data structure portions increase. This is primarily because conventional systems would obfuscate and distribute each of the generated matrix data structure partitions.

The present disclosure provides a system and method that can facilitate greater parallelization by enabling further partitioning of matrix data structure portions into matrix data structure sub-portions without increasing processing load on the distributions computers. This solution is achieved by the present disclosure by using an obfuscation process that obfuscates sets of matrix data structure sub-portions as opposed to obfuscation of each sub-portion, as would occur with prior art systems. The present disclosure can thus increase parallelization without exponentially or at least polynomial increasing computational resource expenditure by distributor computers.

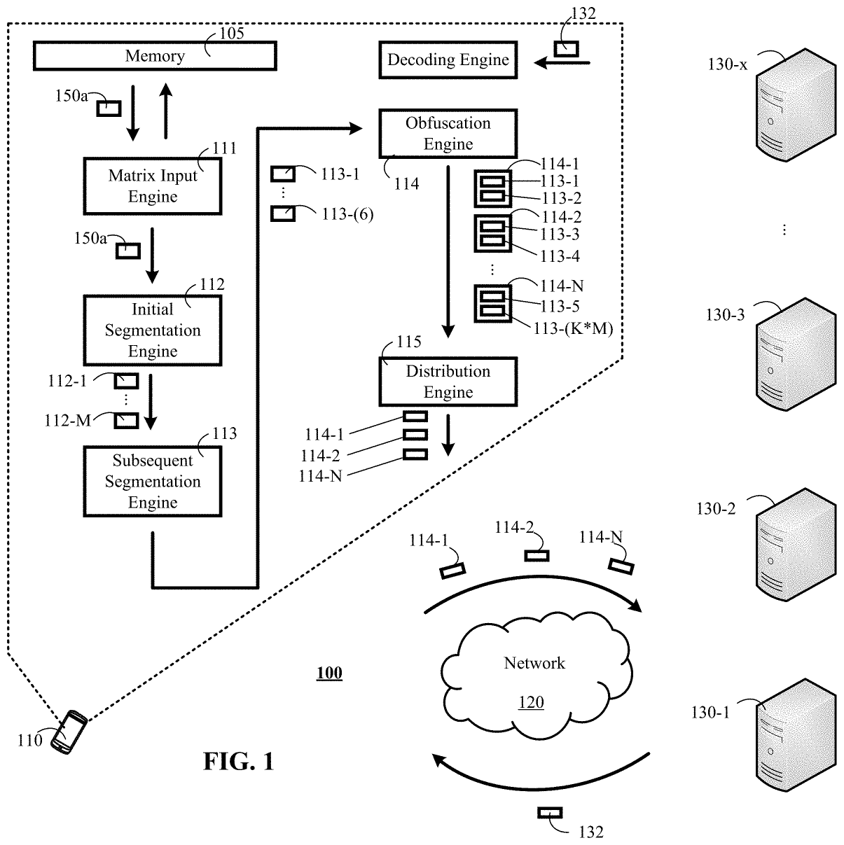

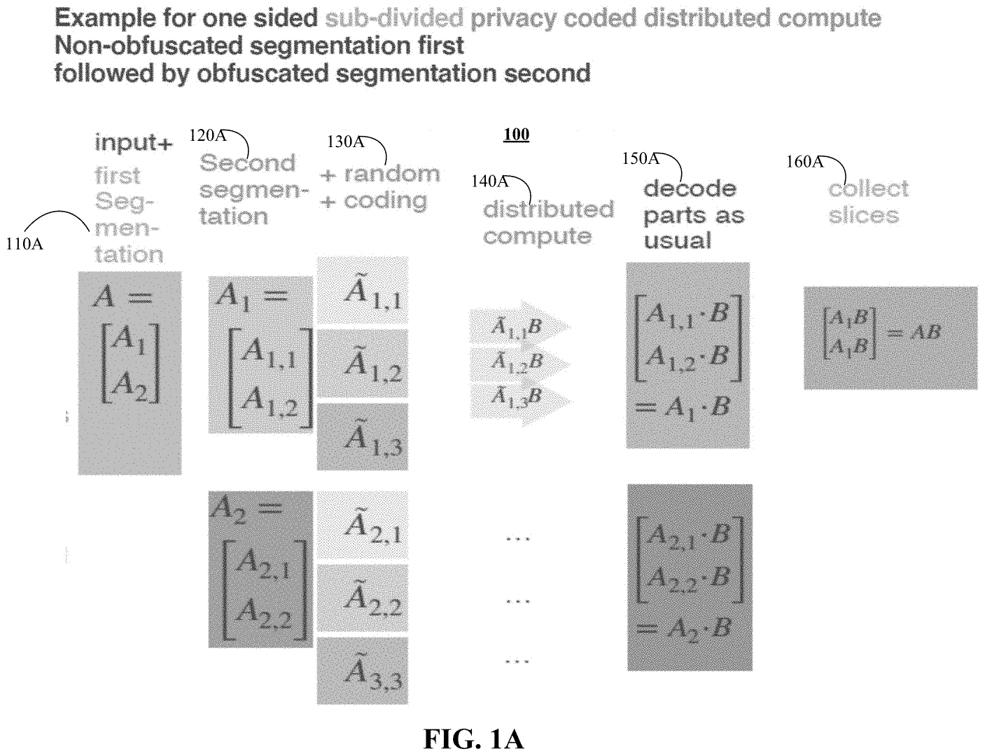

FIG. 1 is an example of a block diagram of an example of a system 100 for optimized distributed private matrix multiplication. The system 100 can include a distribution computer 110, a network 120, and a plurality of worker computers 130-1 to 130-x, wherein x is any positive integer greater than 1. The distribution computer 110 can include a matrix input engine 111, an initial segmentation engine 112, a subsequent segmentation engine 113, an obfuscation engine 114, and a distribution engine 115.

The distribution computer 110 can begin performance of a process for optimized distributed private matrix multiplication by using the matrix input engine 111 to obtain an initial matrix data structure (A) 105a . For example, the matrix input engine 111 can obtain the initial matrix data structure 105a from the memory 105. In some implementations, the obtained initial matrix data structure (A) 105a can correspond to one or different data objects. For example, in some implementations, the obtained initial matrix data structure (A) 105a can correspond to a data object that is to be input to a machine learning model for processing. Such data objects can include an image, a webpage, a feature vector, or any other form of vectorized input for input to a machine learning model. In the system 100, each of the worker computers 130-1 to 130-n (or 130-x) can host such machine learning models for processing matrix data structure sub-portions. The matrix input engine 111 can provide the obtained matrix data structure 105a to the initial segmentation engine 112.

The initial segmentation engine 112 can perform an initial segmentation of the obtained matrix data structure (A) 105a . The initial segmentation engine 112 can segment the obtained matrix data structure (A) into a plurality of M different matrix data structure portions 112-1 to 112-M, where Mis any positive integer greater than 1. Here, the variable Mis used to describe a matrix data structure portion that has not been obfuscated. Matrix data structure portions produced by the initial segmentation engine 112 can be a horizontal stripe of the obtained matrix data structure 105a . In some implementations, this initial segmentation of the obtained matrix data structure 105a can correspond to the types of segmentations performed by conventional systems. The initial segmentation engine 112 can provide the plurality of M different matrix data structure portions 112-1 to 112-M as an input to the subsequent segmentation engine 113.

The subsequent segmentation engine 113 can segment each respective matrix data structure portion 112-1 to 112-M into a plurality of K matrix data structure sub-portions, where K is any positive integer greater than 1. By way of an example with M=3 and K equal to 2, the subsequent segmentation engine 113 can segment (i) the matrix data structure portion 112-1 into 2 matrix data structure sub-portions 113-1 and 113-2, (ii) the matrix data structure portion 112-1 into 2 matrix data structure sub-portions 113-3 and 113-4, and (iii) the matrix data structure 112-Minto 2 matrix data structure sub-portions 113-5 and 113-6. The variable K may also be used to refer to the number of respective sets of matrix data structure sub-portions. In this example, there are K=2 sets of matrix data structure sub-portions across the matrix data structure sub-portions 113-1 to 113-6 (e.g., 113-1 and 113-2 for 112-1; 113-3 and 113-4 for 112-2; and 113-5 and 113-6 for 112-3). The subsequent segmentation engine 113 can provide the matrix data structure sub-portions 113-1 to 113-6 as an input to the obfuscation engine 114.

The obfuscation engine 114 can obtain the respective sets of matrix data structure sub-portions 113-1 to 113-6 and obfuscate the respective sets of matrix data structure sub-portions 113-1 to 113-6. Obfuscating the respective sets of matrix data structure sub-portions 113-1 to 113-6 can include the obfuscation engine 114 generating an obfuscated expression for each of the respective sets of matrix data structure sub-portions 113-1 to 113-6. Obfuscation of the matrix data structure sub-portions 113-1 to 113-6 can protect the privacy of the data encoded by the matrix data structure sub-portions 113-1 to 113-6 so that the matrix data structure sub-portions 113-1 to 113-6 can be processed by trusted or untrusted worker computers 130-1 to 130-x without endangering privacy. The obfuscation engine 114 can obfuscate the matrix data structure sub-portions 113-1 to 113-6 as a function of K sets of matrix data structure sub-portions 113-1 and 113-2, 113-3 and 113-4, and 113-5 and 113-6. For doing so it may use at least one obfuscation matrix, or several of those (not shown explicitly for sake of clarity). These may be added to an expression obtained from the set of data structure sub-portions. The obfuscation matrix can be a randomly generated matrix that has the same dimensions as each of the matrix data structure sub-portions 113-1 through 113-6.

In some implementations, the output of the obfuscation engine 114 is an obfuscated expression 114-1, 114-2, 114-N for each of the K sets of matrix data structures sub-portions. Each obfuscated expression 114-1, 114-2, 114-N can be a set of N matrices of the same size as the matrix data structure sub-portions 113-1 to 113-6. Each of the set of N matrices can be generated from a polynomial that may include, as coefficients, data corresponding to each of the matrix data structure sub-portions 113-1 and 113-2, or 113-3 and 113-4, or 113-5 and 113-6 respectively and the randomly generated matrix data structure. There may be an independent randomly generated matrix data structure for each set to enhance randomness further. In some implementations, each obfuscated expression 114-1, 114-2, 114-N can include a polynomial. Referring to the original matrix data structure 105a as A and each set of matrix data structure sub-portions 113-1 and 113-2 for 112-1; 113-3 and 113-4 for 112-2; and 113-5 and 113-6 for 112-3 as A₁ and A₂ and the randomly generated matrix as R, the first obfuscated expression 114-1 can include A₁=A₁+x₁A₂+x₁²R, where xᵢ is an variable that can be selected by the distributing computer. The remaining obfuscated expressions 114-2, 114-(N) can include:

Ã₂=A₁+x₂A₂+x₂²R. (114-2),

Ã₃=A₁+x₃A₂+x₃²R (114-N).

Though output of the obfuscation engine 114 can thus create N equations with N unknowns i.e., A₁, A₂ and R in this simple example. Each one creates a matrix Ãᵢ i.e. N=3 matrices in this case. If more than one random matrix is used, then N has to be increased accordingly. The output of the obfuscation engine 114 can be provided as an input to the distribution engine 115. The polynomials presented here are rather simple ones for the sake of clarity, however more complex polynomials can be used instead. The number N may also depend on the chosen polynomials. Note that N matrices are generated for each set of K of matrix data structure sub-portions, as there are M sets in total M*N matrices are being generated and forwarded to the distribution engine (not all sets shown for clarity, but only a single set.)

The distribution engine 115 can distribute the obfuscated expressions 114-1 to 114-N to the plurality of worker computers 130-1 to 130-x. Distributing the obfuscated expressions 114-1 can include distributing each of the obfuscated matrix sub-portions to the one of the plurality of worker computers 130-1 to 130-x. Accordingly, for N=3, there will be N*M obfuscated expressions distributed to the sets of work computers. However, the present disclosure is not so limited. Instead, in some implementations, multiple obfuscated matrix sub-portions can be provided to the same worker. In some implementations, the distribution engine 115 can add data to a header field associated with each obfuscated matrix sub-portion to identify the original matrix data structure (e.g., matrix data structure 105a) from which the obfuscated matrix sub-portion was derived. Such header information can be used by the distributor computer 110 to reassemble resultant matrices derived from the obfuscated matrix sub-operation. This is particularly relevant, if the distributor does not directly distribute to the respective workers, but relies on another entity e.g., a separate, dedicated distributor or a distributing network to do so, or does not collect the results directly, and therefore would otherwise not have knowledge about which worker computer and which result relates to which distributed matrix sub-portion.

Though the worker computers are presented in FIG. 1 as remote computers connected to the distribution computer 130-1 to 130-x using one or more networks 120, the present disclosure need not be so limited. For example, in some implementations, the distributions computers 130-1 to 130-x can be different cores of one or more processing units of the distribution computer 110. The networks may be wired or wireless networks or combinations thereof.

Each worker computer 130-1 can process a received obfuscated matrix sub-portion 114-1 to 114-N. Processing the obfuscated matrix sub-portion 114-1 can include, for example, performing a matrix multiplication between the obfuscated matrix sub-potion 114-1 and a different matrix B. This can occur, for example, by processing the obfuscated matrix sub-portion 114-1 through the layers of a machine learning model. Each worker computer can generate an expression that represents a matrix multiplication of a received matrix sub-portion 114-1 to 114-(N) and a different matrix such as matrix B. Each work computer can transmit the generated expression i.e., the matrix multiplication result to the distributor computer 110 using the network 120.

The distributor computer can include a decoding engine 116 that aggregates each of the result matrixes 132-1 to 132-N and then decodes the expressions. In some implementations, the expression can include sum of the matrix multiplications that occurred on each of the coefficients of the processed obfuscated matrix data structure sub-portions. In such implementations, each resultant expression can include a representation of a polynomial sum with unknows. Accordingly, given N expressions and N unknows, the decoding engine 116 can solve the expressions for the unknowns (at least the unknowns of interest for the solution, i.e. not necessarily including unknowns related to obfuscation matrices or matrix products that are not needed for the solution) to determine the result of the matrix multiplication as expressed by A*B from the constituent sub-products Aᵢ*B, where A is the original matrix structure 105a and B is the different matrix structure of the worker computers.

FIG. 1A is an example of process flow 100A for distributed processing of a matrix data structure using post partitioning obfuscation that is one sided obfuscation. In particular, the process flow 100A describes a matrix multiplication A·B, where A is private and B is publicly known.

The process flow 100A begins at stage 110A by using one or more computers to split matrix A into m stripes. In the example of process flow 100A, m is equal to 2, i.e. matrix a is split into two stripes A₁, A₂. Execution of the process flow 100A can continue at stage 120A by using one or more computers to split each of the stripes into K=2 sub-stripes i.e. stripe A₁ is split into sub-stripes A_{1,1}, A_{1,2}, and stripe A₂ is split into sub-stripes A_{2,1}, A_{2,2}. Execution of the process flow 100A can continue at stage 130 by using one or more computers to encode each of the sub-stripes using polynomials. Encoding a sub-stripe such as sub-stripe A₁ using a polynomial can, e.g., result in the following polynomial:

Ã_{1,i}=A_{1,1}+xᵢA_{1,2}+xᵢ²R,

where R is a randomly generated matrix. The aforementioned polynomial results in N=3 different Ã_{1,i} and the encoding stage can also include using one or more computers to similarly generate Ã_{2,i} from A₂.

Execution of the process flow 100A can continue at stage 140A by using one or more computers to distribute to m*N worker computers. Then, each worker computer is configured to multiply each sub-stripe with a matrix B to generate and return Ã_{i,j}B. Execution of the process flow 100A can continue at stage 150A by using one or more computers to decode via interpolation of polynomials to get A_{i,j}B for all i,j and generate AᵢB for all i. Execution of the process 100A can continue at stage 160A by collecting each of the slices of results into AB.

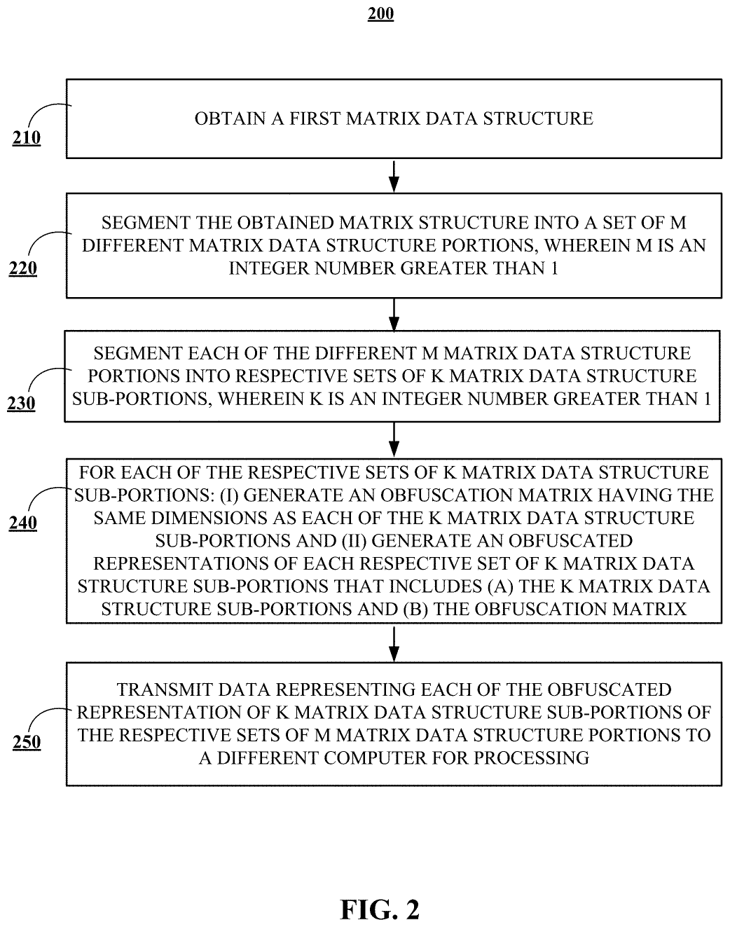

FIG. 2 is a flowchart of an example of a method 200 for distributed processing of a matrix data structure using post-partitioning, one-side obfuscation. One-sided obfuscation can include obfuscating the input data matrix to be processed by each distributed worker. In one aspect, the method can include obtaining, by one or more computers, a first matrix data structure (210), segmenting, by one or more computers, the obtained matrix data structure into a set of M different matrix data structure portions, wherein M is an integer number greater than 1 (220), segmenting, by one or more computers, each of the different M matrix data structure portions into respective sets of K matrix data structure sub-portions, where K is an integer number greater than 1 (230), for each of the respective sets of K matrix data structure sub-portions: generating, by one or more computers, an obfuscation matrix having the same dimensions as each of the K matrix data structure sub-portions generating, by one or more computers, an obfuscated representation of each respective set of K matrix data structure sub-portions that includes (i) the K matrix data structure sub-portions and (ii) the obfuscation matrix (240), and transmitting, by one or more computers, data representing each (of the N per set of K or in total M*N) obfuscated representation of the (K) matrix data structure sub-portions of the respective sets to a different computer for processing (250).

In some implementations, the method 200 can also include receiving, by one or more computers, result data that includes a resultant matrix from each of the different computers, wherein each resultant matrix of the M*N resultant matrices is a product of (a) a different matrix and (b) an obfuscated representation of one of the M*N matrix data structure sub-portions.

In some implementations, the method 200 can also include decoding, by one or more computers, the result data, wherein decoding the result data that include identifying, by one or more computers and for each resultant matrix, a particular resultant matrix that is a product of the different matrix and one of the K matrix data structures.

In some implementations, the method 200 can include generating, by one or more computers, an obfuscated representation of each respective set of K matrix data structure sub-portions that includes (i) the K matrix data structure portions and (ii) the obfuscation matrix comprises: generating, by one or more computers, an expression that corresponds to a polynomial having one or more of the K matrix data structure sub-portions as a coefficient and one or more obfuscation matrices as coefficients.

In some implementations, the method 200 can further include receiving, by one or more computers, a set of result data from each of the different computers, wherein each set of result data includes data representing an expression that corresponds to a product of (a) a different matrix and (b) the generated expression, and in such implementations, decoding, by one or more computers, the result data, wherein decoding the result data can include determining, by one or more computers, that the generated expression in each set of result data has unknown parameters and identifying, by one or more computers and based on the generated expressions and the unknown parameters for each expression, a particular resultant matrix that is a product of the different matrix and one of the K matrix data structures.

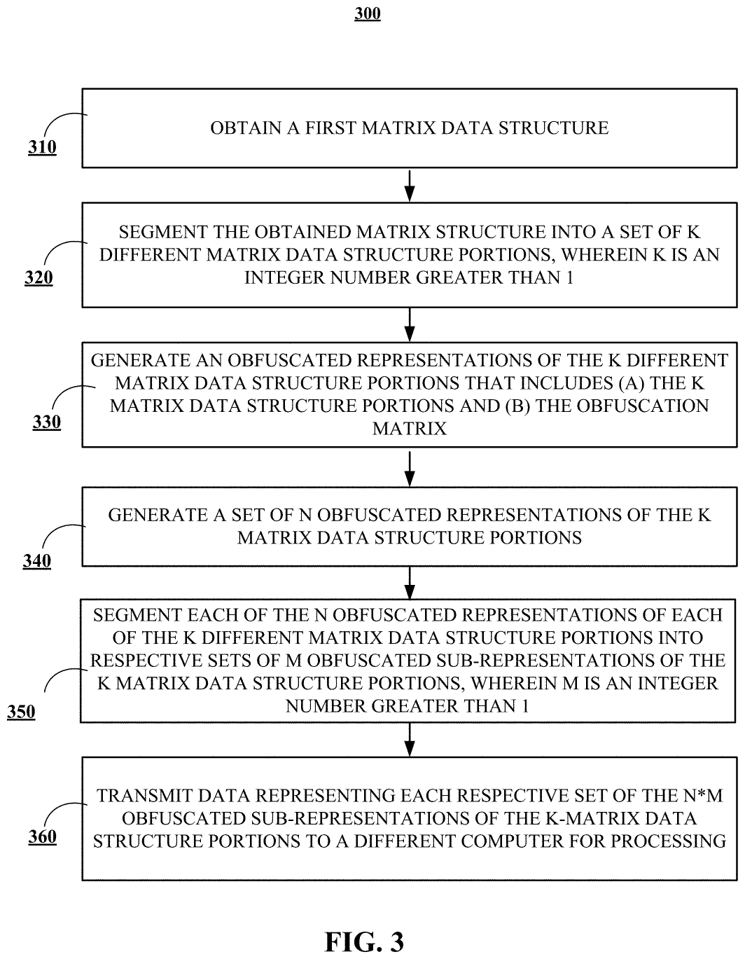

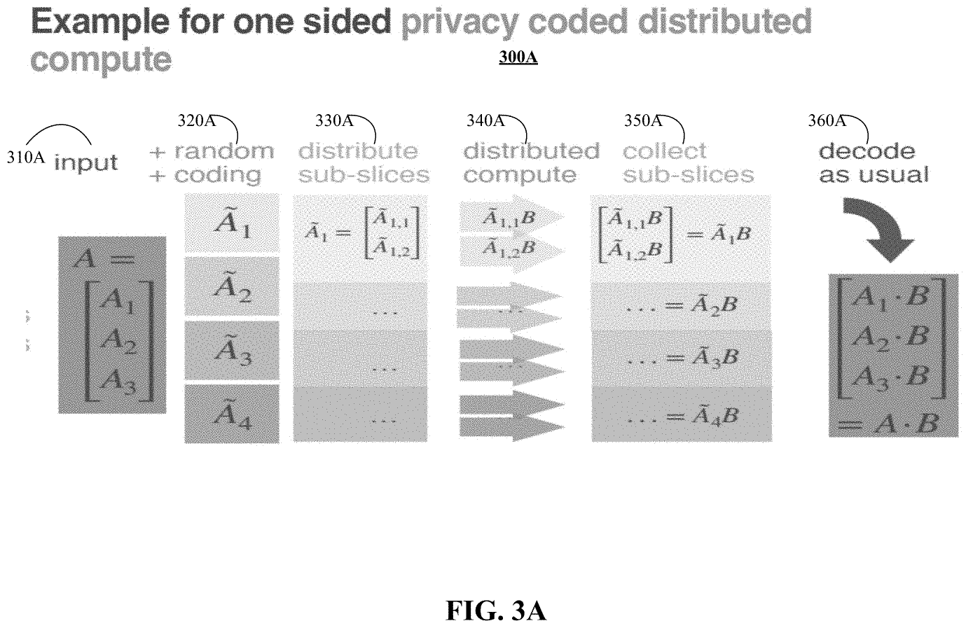

The aforementioned examples of FIGS. 1 and 2 described examples of post-segmentation obfuscation, where the obfuscation is done in the second segmentation step. However, the present disclosure is not so limited. Instead, in some implementations, the present disclosure can employ pre-segmentation obfuscation, where the obfuscation is done in the first segmentation step. Such an example is captured by the process of FIG. 3.

FIG. 3 is a flowchart of an example of a method 300 for distributed processing of a matrix data structure using pre-segmentation obfuscation, one-sided obfuscation. In one aspect, the method can include actions of obtaining, by one or more computers, a first matrix data structure (310), segmenting, by one or more computers, the obtained matrix data structure into a set of K different matrix data structure portions, wherein K is an integer number greater than 1 (320), generating, by one or more computers, an obfuscated representation of the K different matrix data structure portions that includes (i) the K matrix data structure portions and (ii) the obfuscation matrix (330), generating a set of N obfuscated representations of the K matrix data structure portions (340), segmenting, by one or more computers, each of the N obfuscated representations of each of the K different matrix data structure portions into respective sets of M obfuscated sub-representations of the K matrix data structure portions, where M is an integer number greater than 1 (350), and transmitting, by one or more computers, data representing each respective set of the N*M obfuscated sub-representations (of the K matrix data structure portion) to a different computer for processing (360).

FIG. 3A is an example of a process flow 300A for distributed processing of a matrix data structure using pre-segmentation obfuscation that is one-sided obfuscation. In particular, the process flow 300A describes a matrix multiplication A·B, where A is private and B is publicly known.

The process flow 300A begins at stage 310A by using one or more computers to split matrix A into K=3 stripes. Execution of the process flow 300A can continue at stage 320A by using one or more computers to encode each of the stripes using polynomials. Encoding a stripe such as tripe A₁ using a polynomial can, e.g., result in the following polynomial:

Ãᵢ=A₁+xᵢA₂+xᵢ²A₃+xᵢ³R,

where R is a randomly generated matrix. The aforementioned encoding process results in 4 different Ãᵢ.

Execution of the process flow 300A can continue at stage 330A by using one or more computers to split each of those Ãᵢ into m further sub-stripes and then distribute each of the subs-slices for processing by one or more worker computers. In the example of process flow 300A, m is equal to 2. Execution of the process flow 300A can continue at stage 340A by using one or more worker computers to multiply its received sub-stripe by a matrix B in order to generate and return Ã_{i,1}B and Ã_{i,2}B.

Execution of the process flow 300A can continue at stage 350A by using one or more computers to collect the generated results of each worker computer into ÃᵢB. Execution of the process flow 300A can continue at stage 360A by using one or more computers to decode via interpolation of polynomials to get AᵢB and then AB.

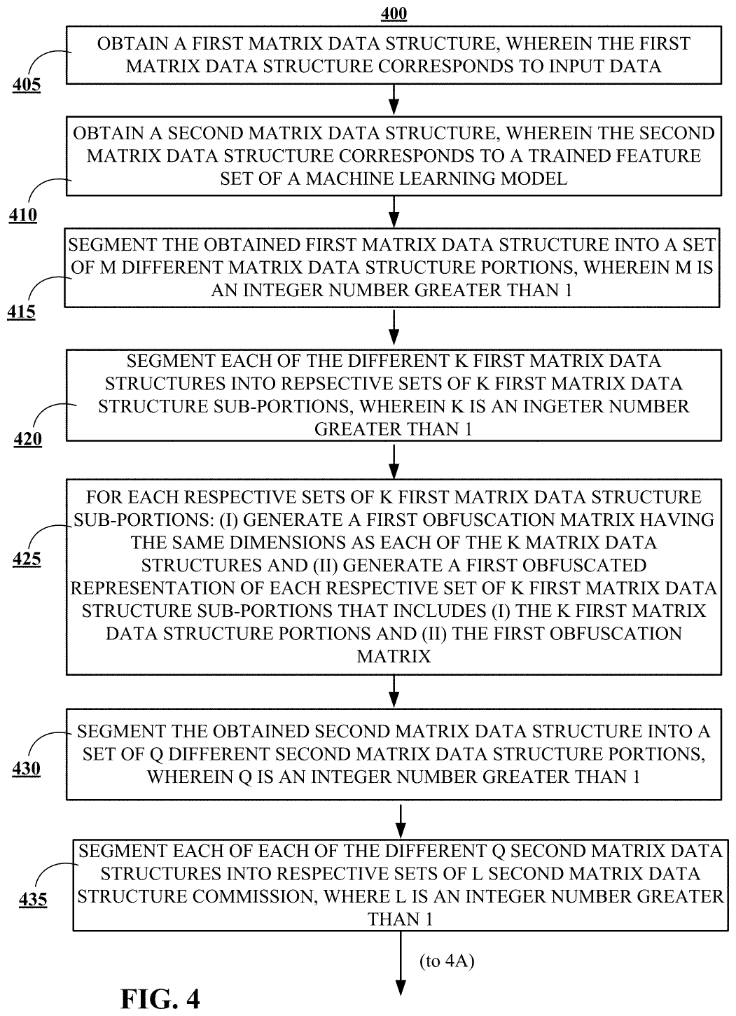

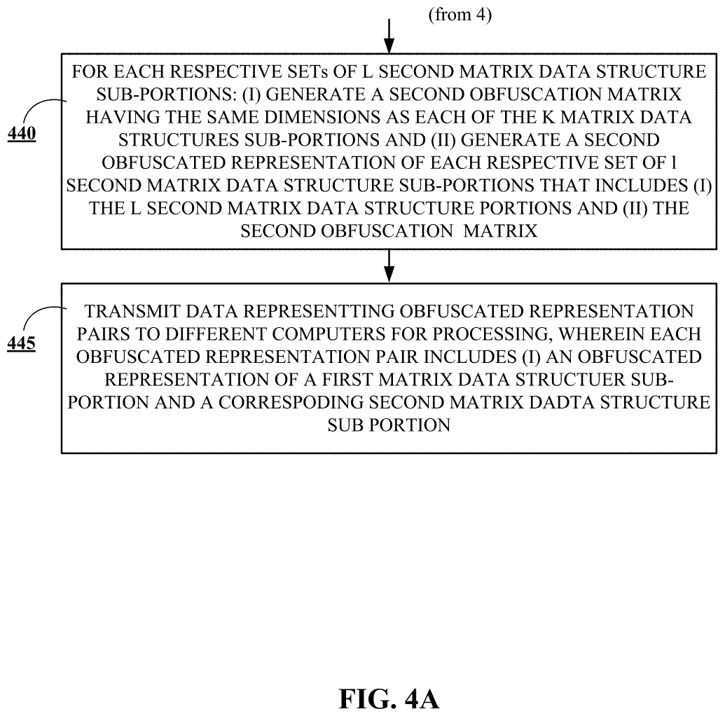

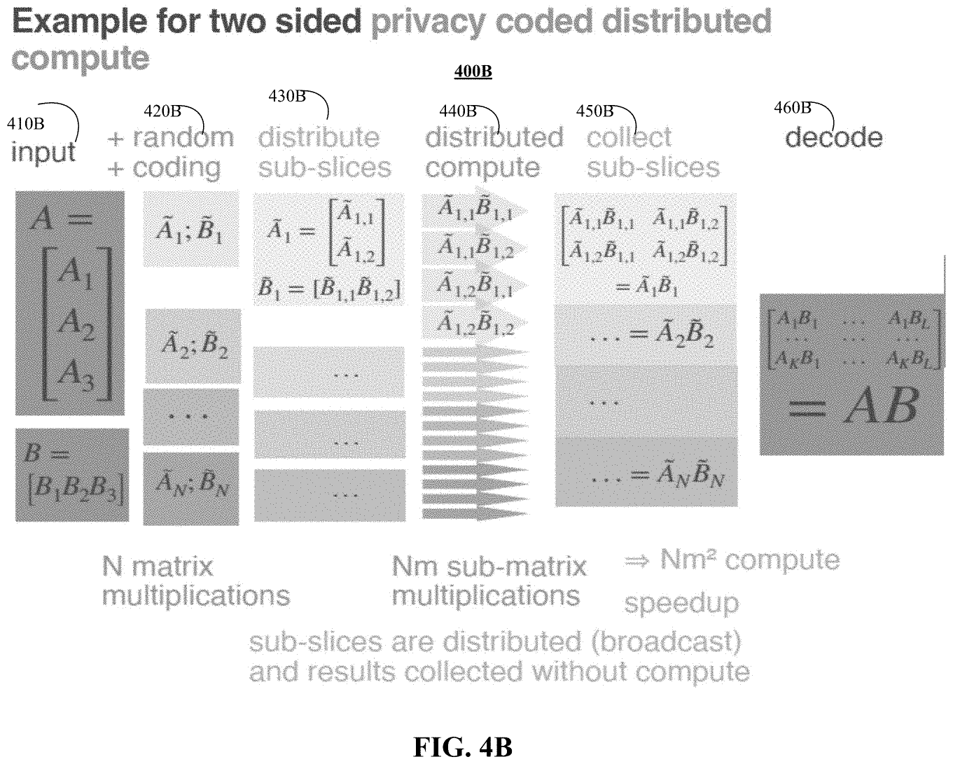

The aforementioned examples include a description of implementations using one-sided obfuscation. However, the present disclosure is not so limited. Instead, in some implementations, the present disclosure can implement two-sided obfuscation. With two-sided obfuscation, both the input matrix data structure sub-portion and the different matrix that is to be used by a worker computer for a multiplication operation can be obfuscated by the distributor computers 110. Such two-sided obfuscation is described with reference to FIG. 4.

FIGS. 4-4A include a flowchart of an example of a method 400 for optimized distributed private matrix multiplication using pre-segmentation obfuscation that is two-sided obfuscation implementation. The method includes a series of different stages from stage 405 to stage 445. For simplicity, here K=L and M=Q could be selected, i.e. both matrices could be split evenly.

In one aspect, the method 400 can begin at stage 405 of FIG. 4 by obtaining, by one or more computers, a first matrix data structure, wherein the first matrix data structure corresponds to input data (405), obtaining, by one or more computers, a second matrix data structure, wherein the second matrix data structure corresponds to a trained feature set of a machine learning model (410), segmenting, by one or more computers, the obtained first matrix data structure into a set of M different first matrix data structure portions, wherein M is an integer number greater than 1 (415), segmenting, by one or more computers, each of the different K first matrix data structures into respective sets of K first matrix data structure sub-portions, where K is an integer number greater than 1 (420), for each of the respective sets of K first matrix data structure sub-portions: (I) generating, by one or more computers, a first obfuscation matrix having the same dimensions as each of the K matrix data structure sub-portions, and (II) generating, by one or more computers, a first obfuscated representation of each respective set of K first matrix data structure sub-portions that includes (i) the K first matrix data structure sub-portions and (ii) the first obfuscation matrix (425), segmenting, by one or more computers, the obtained second matrix data structure into a set of [symbol] different second matrix data structure portions, wherein [symbol] is an integer number greater than 1 (430), and segmenting, by one or more computers, each of the different [symbol] second matrix data structures into respective sets of L second matrix data structure sub-portions, where L is an integer number greater than 1 (435).

Then execution of the process 400 can continue at stage 440 of FIG. 4A where execution of stage 440 includes for each of the respective sets of L second matrix data structure sub-portions: generating, by one or more computers, a second obfuscation matrix having the same dimensions as each of the K second matrix data structure sub-portions, generating, by one or more computers, a second obfuscated representation of each respective set of L second matrix data structure sub-portions that includes (i) the L second matrix data structure sub-portions and (ii) the second obfuscation matrix (440). Then, the process 400 can conclude at stage 445 by transmitting, by one or more computers, data representing obfuscated representation pairs to different computers for processing, wherein each obfuscated representation pair includes (i) an obfuscated representation of a first matrix data structure sub-portion and a corresponding second matrix data structure sub-portion (445).

Protecting the privacy of both matrices is beneficial if the trained model would reveal information in an undesired way, e.g., because the model has been trained using private data and might thus indirectly reveal properties of these private data. Another reason may be that the model would reveal the intent of the user e.g., discriminating pictures of malicious from non-malicious tissue by using a model trained for that purpose, which is to be kept private. However, there may be other applications as well benefiting from such a privacy, e.g., analysis of business analytics data aiding investments which should not become public, as that might offer competitors an advantage.

In the two-sided case mentioned above, for the sake of simplicity, both matrices can be segmented into the same number of K different first matrix data structure portions respectively sets ofM first matrix data structure sub-portions. However, the numbers may be different for the two matrices as well e.g., using L instead of K and Q instead of M for the second matrix. For some splits it is even possible to use different numbers in the second splitting for the different to be split matrices, instead of always using the same number (not shown for clarity). In some implementations, for example, some matrices may not be split at all which is equivalent to setting M=1 or Q=1, as long as this is not done for all the matrices (as this would revert to the method without any sub-splitting) i.e., at least one matrix is split into more than one second matrix. This may be beneficial if different workers have different compute capability, so splitting some of the work into smaller segments may make those more suitable to the workers with lower compute capabilities while sending larger segments or even unsplit matrices to the workers with higher compute capabilities may make better use of those workers' capabilities.

In the two sided example either first the two matrices are split in a first segmenting step using obfuscation and then in a second step without obfuscation. However, as shown for the one-sided case, the first step can be done without obfuscation and the second step using obfuscation as a further alternative. The method is similar as described for the one sided case, but applied to both the first and second matrix in a similar way as shown above, just reversing the order of obfuscated segmentation and non-obfuscated segmentation.

Generally speaking, a concept of the presented invention is to combine obfuscated segmentation and non-obfuscated segmentation in any order and for any number of involved matrices. By spending less effort on obfuscation than in a corresponding single step obfuscated segmentation, the inventive procedure consumes less compute efforts for obtaining a similar compound segmentation. M and Q are used for designating the segmentation in a nun-obfuscated manner, while K and L are used to denote the segmentations in a obfuscated manner. In the latter case, to be able to recover that data despite obfuscation, N obfuscated matrix sub portions need to be generated to receive back N results from which the desired result (removing the obfuscation) can be derived. The value of N depends on the specifics of the obfuscation method and the segmentation i.e., K and/or L.

The arithmetic used to calculate polynomials can be ordinary arithmetic used by computers like 16 bit arithmetic or using any number of bits suitable for the computation task, it may however also be done using some variant of finite field arithmetic which provides some advantages in easing the solving of the received results for the desired matrix sub products.

FIG. 4B is an example of a process flow 400B for a process for distributed processing of a matrix data structure using pre-segmentation obfuscation that is two-sided obfuscation. In particular, the process flow 400B describes a matrix multiplication A·B, where matrix A and matrix B are both private.

The process flow 400B begins at stage 410B by using one or more computers to split matrix A and matrix B into K=L=3 stripes. Execution of the process 400B can continue at stage 420B by using one or more computers to encode the stripes using polynomials and T random matrices for privacy. Encoding stripe such as stripe A₁ using a polynomial and T random matrices for privacy can, e.g., result in the following expression: Ãᵢ=f (xᵢ); \tilde{B}(xᵢ), giving i=1, . . . N with N≤(K+T)(L+T), different sets of Ãᵢ and \tilde{B}ᵢ. The polynomials f (xᵢ) respectively g(xᵢ) may contain as coefficients the stripes A₁, A₂, and A₃, respectively B₁, B₂, and B₃.

Execution of the process flow 400B can continue at stage 430B by using one or more computers to split each of the Ãᵢ and \tilde{B}ᵢ into further sub-stripes Ã_{i,j} and j=1, . . . M; k=1, . . . Q and then distribute each pair to MQ worker computers. In the example of process flow 400B, M and Q are both equal to 2 i.e. M=Q=m=2, giving m² workers for each of the N pairs Ãᵢ and \tilde{B}ᵢ and consequently NMQ=Nm² workers in total. Execution of the process flow 400B can continue at stage 440B by using each of the worker computers to multiply sub-stripes Ã_{i,j} and \tilde{B}_{i,k} in order to generate and return Ã_{i,j}\tilde{B}_{i,k}. Execution of the process flow 400B can continue by using one or more computers to collect the generated Ã_{i,j}\tilde{B}_{i,k} into Ãᵢ\tilde{B}ᵢ.

Execution of the process flow 400B can continue at stage 460B by using one or more computers to decode Ãᵢ\tilde{B}ᵢ by determining polynomial coefficients in order to get AᵢBⱼ and eventually AB. Note that the indices (i,j,k) are used for all sets e.g., Aᵢ, Bⱼ, Ãᵢ, \tilde{B}ᵢ, Ã_{i,j}, \tilde{B}_{i,j} within the relevant context for simplicity of notation, in a computer program implementation distinct indices may have to be used to avoid overloading variables.

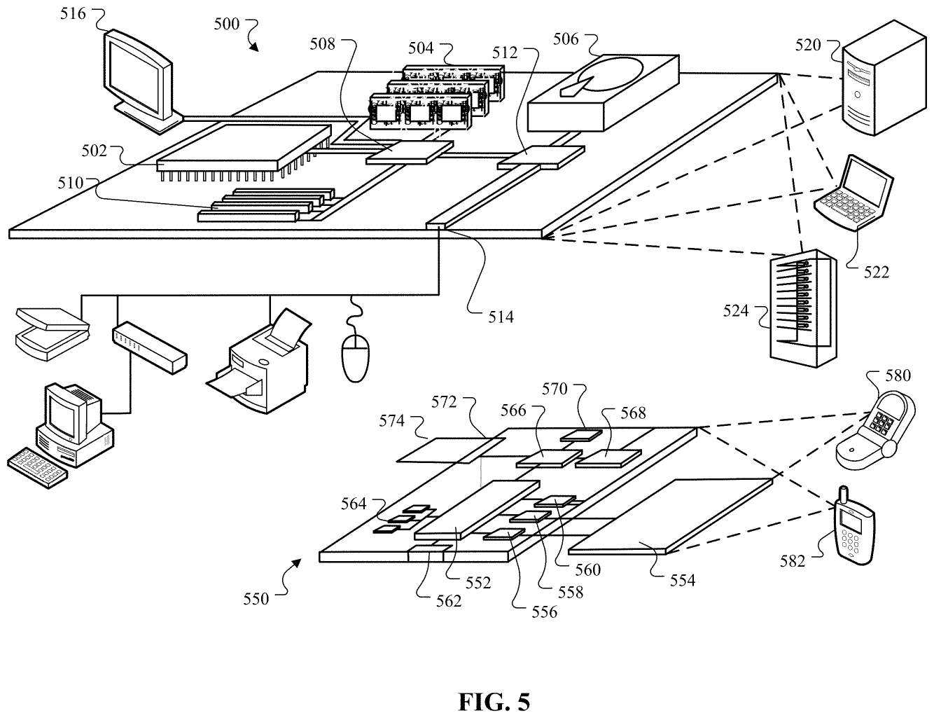

FIG. 5 is a block diagram 500 of system components that can be used to implement a system for optimized private matrix multiplication.

Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally, computing device 500 or 550 can include Universal Serial Bus (USB) flash drives. The USB flash drives can store operating systems and other applications. The USB flash drives can include input/output components, such as a wireless transmitter or USB connector that can be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses can be used, as appropriate, along with multiple memories and types of memory. Also, multiple computing devices 500 can be connected, with each device providing portions of the necessary operations, e.g., as a server bank, a group of blade servers, or a multi-processor system.

The memory 504 stores information within the computing device 500. In one implementation, the memory 504 is a volatile memory unit or units. In another implementation, the memory 504 is a non-volatile memory unit or units. The memory 504 can also be another form of computer-readable medium, such as a magnetic or optical disk.

The storage device 506 is capable of providing mass storage for the computing device 500. In one implementation, the storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth intensive operations. Such allocation of functions is exemplary only. In one implementation, the high-speed controller 508 is coupled to memory 504, display 516, e.g., through a graphics processor or accelerator, and to high-speed expansion ports 510, which can accept various expansion cards (not shown). In the implementation, low-speed controller 512 is coupled to storage device 506 and low-speed expansion port 514. The low-speed expansion port, which can include various communication ports, e.g., USB, Bluetooth, Ethernet, wireless Ethernet can be coupled to one or more input/output devices, such as a keyboard, a pointing device, microphone/speaker pair, a scanner, or a networking device such as a switch or router, e.g., through a network adapter. The computing device 500 can be implemented in a number of different forms, as shown in the figure. For example, it can be implemented as a standard server 520, or multiple times in a group of such servers. It can also be implemented as part of a rack server system 524. In addition, it can be implemented in a personal computer such as a laptop computer 522. Alternatively, components from computing device 500 can be combined with other components in a mobile device (not shown), such as device 550. Each of such devices can contain one or more of computing device 500, 550, and an entire system can be made up of multiple computing devices 500, 550 communicating with each other.

The computing device 500 can be implemented in a number of different forms, as shown in the figure. For example, it can be implemented as a standard server 520, or multiple times in a group of such servers. It can also be implemented as part of a rack server system 524. In addition, it can be implemented in a personal computer such as a laptop computer 522. Alternatively, components from computing device 500 can be combined with other components in a mobile device (not shown), such as device 550. Each of such devices can contain one or more of computing device 500, 550, and an entire system can be made up of multiple computing devices 500, 550 communicating with each other.

Computing device 550 includes a processor 552, memory 564, and an input/output device such as a display 554, a communication interface 566, and a transceiver 568, among other components. The device 550 can also be provided with a storage device, such as a micro-drive or other device, to provide additional storage. Each of the components 550, 552, 564, 554, 566, and 568, are interconnected using various buses, and several of the components can be mounted on a common motherboard or in other manners as appropriate.

The processor 552 can execute instructions within the computing device 550, including instructions stored in the memory 564. The processor can be implemented as a chipset of chips that include separate and multiple analog and digital processors. Additionally, the processor can be implemented using any of a number of architectures. For example, the processor 510 can be a CISC (Complex Instruction Set Computers) processor, a RISC (Reduced Instruction Set Computer) processor, or a MISC (Minimal Instruction Set Computer) processor. The processor can provide, for example, for coordination of the other components of the device 550, such as control of user interfaces, applications run by device 550, and wireless communication by device 550.

Processor 552 can communicate with a user through control interface 558 and display interface 556 coupled to a display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can be provide in communication with processor 552, so as to enable near area communication of device 550 with other devices. External interface 562 can provide, for example, for wired communication in some implementations, or for wireless communication in other implementations, and multiple interfaces can also be used.

The memory 564 stores information within the computing device 550. The memory 564 can be implemented as one or more of a computer-readable medium or media, a volatile memory unit or units, or a non-volatile memory unit or units. Expansion memory 574 can also be provided and connected to device 550 through expansion interface 572, which can include, for example, a SIMM (Single In Line Memory Module) card interface. Such expansion memory 574 can provide extra storage space for device 550, or can also store applications or other information for device 550. Specifically, expansion memory 574 can include instructions to carry out or supplement the processes described above, and can include secure information also. Thus, for example, expansion memory 574 can be provide as a security module for device 550, and can be programmed with instructions that permit secure use of device 550. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that can be received, for example, over transceiver 568 or external interface 562.

Device 550 can communicate wirelessly through communication interface 566, which can include digital signal processing circuitry where necessary. Communication interface 566 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 568. In addition, short-range communication can occur, such as using a Bluetooth, Wi-Fi, or other such transceiver (not shown). In addition, GPS (Global Positioning System) receiver module 570 can provide additional navigation- and location-related wireless data to device 550, which can be used as appropriate by applications running on device 550.

Device 550 can also communicate audibly using audio codec 560, which can receive spoken information from a user and convert it to usable digital information. Audio codec 560 can likewise generate audible sound for a user, such as through a speaker, e.g., in a handset of device 550. Such sound can include sound from voice telephone calls, can include recorded sound, e.g., voice messages, music files, etc. and can also include sound generated by applications operating on device 550.

The computing device 550 can be implemented in a number of different forms, as shown in the figure. For example, it can be implemented as a cellular telephone 580. It can also be implemented as part of a smartphone 582, personal digital assistant, or other similar mobile device.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

### Other Embodiments

A number of embodiments have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A method for distributed processing of a matrix data structure comprising:
obtaining, by one or more computers, a first matrix data structure;
segmenting, by one or more computers, the obtained matrix data structure into a set of M different matrix data structure portions, wherein M is an integer number greater than 1;
segmenting, by one or more computers, each of the different M matrix data structure portions into respective sets of K matrix data structure sub-portions, where K is an integer number greater than 1;
for each of the respective sets of K matrix data structure sub-portions:
generating, by one or more computers, an obfuscation matrix having the same dimensions as each of the K matrix data structure sub-portions; and
generating, by one or more computers, an obfuscated representation of each respective set of K matrix data structure sub-portions that includes (i) the K matrix data structure sub-portions and (ii) the obfuscation matrix; and
transmitting, by one or more computers, data representing each (of the N) obfuscated representations of the (K) matrix data structure sub-portions of the respective sets of M matrix data structure portions to a different computer for processing.

2. The method of claim 1, the method further comprising:
receiving, by one or more computers, result data that includes a resultant matrix from each of the different computers, wherein each resultant matrix of the resultant matrices is a product of (a) a different matrix and (b) an obfuscated representation of one of the M matrix data structure sub-portions; and
decoding, by one or more computers, the result data, wherein decoding the result data comprises:
identifying, by one or more computers and for each resultant matrix, a particular resultant matrix that is a product of the different matrix and one of the K matrix data structures.

3. The method of claim 1, wherein generating, by one or more computers, an obfuscated representation of each respective set of K matrix data structure sub-portions that includes (i) the K matrix data structure portions and (ii) the obfuscation matrix comprises:
generating, by one or more computers, an expression that corresponds to a polynomial having at least one of the K matrix data structure sub-portions as a coefficient and an obfuscation matrix as coefficients.

4. The method of claim 3, the method further comprising:
receiving, by one or more computers, a set of result data from each of the different computers, wherein each set of result data includes data representing an expression that corresponds to a product of (a) a different matrix and (b) the generated expression; and
decoding, by one or more computers, the result data, wherein decoding the result data comprises:
determining, by one or more computers, that the generated expression in each set of result data has unknown parameters;
identifying, by one or more computers and based on the generated expressions the relevant unknown parameters for each expression, a particular resultant matrix that is a product of the different matrix and one of the K matrix data structures.

5. The method of claim 1, wherein transmitting, by one or more computers, data representing each (of the N) obfuscated representation of the (K) matrix data structure sub-portions of the respective sets of M matrix data structure portions to a different computer for processing comprises:
for each particular obfuscated representation of the N obfuscated representations:
transmitting the particular obfuscated representation to a different remote computer that is remote from the one or more computers using one or more networks.

6. The method of claim 1, wherein transmitting, by one or more computers, data representing each (of the N) obfuscated representation of the (K) matrix data structure sub-portions of the respective sets of M matrix data structure portions to a different computer for processing comprises:
for each particular obfuscated representation of the N obfuscated representations:
transmitting the particular obfuscated representation to a different processing core of one the one or more computers.

7. A system comprising:
one or more computers; and
one or more memories storing instructions that, when executed by the one or more computers, cause the one or more computers to perform operations, the operations comprising:
obtaining, by one or more computers, a first matrix data structure;
segmenting, by one or more computers, the obtained matrix data structure into a set of M different matrix data structure portions, wherein M is an integer number greater than 1;
segmenting, by one or more computers, each of the different M matrix data structure portions into respective sets of K matrix data structure sub-portions, where K is an integer number greater than 1;
for each of the respective sets of K matrix data structure sub-portions:
generating, by one or more computers, an obfuscation matrix having the same dimensions as each of the K matrix data structure sub-portions; and
generating, by one or more computers, an obfuscated representation of each respective set of K matrix data structure sub-portions that includes (i) the K matrix data structure sub-portions and (ii) the obfuscation matrix; and
transmitting, by one or more computers, data representing each (of the N) obfuscated representation of the (K) matrix data structure sub-portions of the respective sets of M matrix data structure portions to a different computer for processing.

8. The system of claim 7, the operations further comprising:
receiving, by one or more computers, result data that includes a resultant matrix from each of the different computers, wherein each resultant matrix of the resultant matrices is a product of (a) a different matrix and (b) an obfuscated representation of one of the M matrix data structure sub-portions; and
decoding, by one or more computers, the result data, wherein decoding the result data comprises:
identifying, by one or more computers and for each resultant matrix, a particular resultant matrix that is a product of the different matrix and one of the K matrix data structures.

9. The system of claim 7, wherein generating, by one or more computers, an obfuscated representation of each respective set of K matrix data structure sub-portions that includes (i) the K matrix data structure portions and (ii) the obfuscation matrix comprises:
generating, by one or more computers, an expression that corresponds to a polynomial having at least one of the K matrix data structure sub-portions as a coefficient and an obfuscation matrix as coefficients.

10. The system of claim 9, the operations further comprising:
receiving, by one or more computers, a set of result data from each of the different computers, wherein each set of result data includes data representing an expression that corresponds to a product of (a) a different matrix and (b) the generated expression; and
decoding, by one or more computers, the result data, wherein decoding the result data comprises:
determining, by one or more computers, that the generated expression in each set of result data has unknown parameters;
identifying, by one or more computers and based on the generated expressions the relevant unknown parameters for each expression, a particular resultant matrix that is a product of the different matrix and one of the K matrix data structures.

11. The system of claim 7, wherein transmitting, by one or more computers, data representing each (of the N) obfuscated representation of the (K) matrix data structure sub-portions of the respective sets of M matrix data structure portions to a different computer for processing comprises:
for each particular obfuscated representation of the N obfuscated representations:
transmitting the particular obfuscated representation to a different remote computer that is remote from the one or more computers using one or more networks.

12. The system of claim 7, wherein transmitting, by one or more computers, data representing each (of the N) obfuscated representation of the (K) matrix data structure sub-portions of the respective sets of M matrix data structure portions to a different computer for processing comprises:
for each particular obfuscated representation of the N obfuscated representations:
transmitting the particular obfuscated representation to a different processing core of one the one or more computers.

13. One or more computer-readable media storing instructions that, when executed by one or more computers, cause the one or more computers to perform operations, the operations comprising:
obtaining, by one or more computers, a first matrix data structure;
segmenting, by one or more computers, the obtained matrix data structure into a set of M different matrix data structure portions, wherein M is an integer number greater than 1;
segmenting, by one or more computers, each of the different M matrix data structure portions into respective sets of K matrix data structure sub-portions, where K is an integer number greater than 1;
for each of the respective sets of K matrix data structure sub-portions:
generating, by one or more computers, an obfuscation matrix having the same dimensions as each of the K matrix data structure sub-portions; and
generating, by one or more computers, an obfuscated representation of each respective set of K matrix data structure sub-portions that includes (i) the K matrix data structure sub-portions and (ii) the obfuscation matrix; and
transmitting, by one or more computers, data representing each (of the N) obfuscated representation of the (K) matrix data structure sub-portions of the respective sets of M matrix data structure portions to a different computer for processing.

14. The computer-readable medium of claim 13, the operations further comprising:
receiving, by one or more computers, result data that includes a resultant matrix from each of the different computers, wherein each resultant matrix of the resultant matrices is a product of (a) a different matrix and (b) an obfuscated representation of one of the M matrix data structure sub-portions; and
decoding, by one or more computers, the result data, wherein decoding the result data comprises:
identifying, by one or more computers and for each resultant matrix, a particular resultant matrix that is a product of the different matrix and one of the K matrix data structures.

15. The computer-readable medium of claim 13, wherein generating, by one or more computers, an obfuscated representation of each respective set of K matrix data structure sub-portions that includes (i) the K matrix data structure portions and (ii) the obfuscation matrix comprises:
generating, by one or more computers, an expression that corresponds to a polynomial having at least one of the K matrix data structure sub-portions as a coefficient and an obfuscation matrix as coefficients.

16. The computer-readable medium of claim 15, the operations further comprising:
receiving, by one or more computers, a set of result data from each of the different computers, wherein each set of result data includes data representing an expression that corresponds to a product of (a) a different matrix and (b) the generated expression; and
decoding, by one or more computers, the result data, wherein decoding the result data comprises:
determining, by one or more computers, that the generated expression in each set of result data has unknown parameters;
identifying, by one or more computers and based on the generated expressions the relevant unknown parameters for each expression, a particular resultant matrix that is a product of the different matrix and one of the K matrix data structures.

17. The computer-readable medium of claim 13, wherein transmitting, by one or more computers, data representing each (of the N) obfuscated representation of the (K) matrix data structure sub-portions of the respective sets of M matrix data structure portions to a different computer for processing comprises:
for each particular obfuscated representation of the N obfuscated representations:
transmitting the particular obfuscated representation to a different remote computer that is remote from the one or more computers using one or more networks.

18. The computer-readable medium of claim 13, wherein transmitting, by one or more computers, data representing each (of the N) obfuscated representation of the (K) matrix data structure sub-portions of the respective sets of M matrix data structure portions to a different computer for processing comprises:
for each particular obfuscated representation of the N obfuscated representations:
transmitting the particular obfuscated representation to a different processing core of one the one or more computers.
